(19) United States
(12) Patent Application Publication
(10) Pub. No.: US 2004/0198435 A1
(43) Pub. Date: Oct. 7, 2004

(54) Camera integration on a mobile device

(76) Inventors: Craig Stephen Gauld, Vancouver (CA); Jon Theron Winebrenner, Vancouver (CA); Harish Kumar Patel, Burnaby (CA); Michael Robert King, Burnaby (CA); Andrew Stanely Guy Harries, Vancouver (CA)

Correspondence Address: Robert E. Krebs, Thelen Reid & Priest LLP, P.O. Box 640640, San Jose, CA, 95164-0640, US

(21) Appl. No.: 10/358,497

(22) Filed: Feb. 4, 2003

Related U.S. Application Data
(60) Provisional application No. 60/386,989, filed on Jun. 7, 2002.

(51) Int. Cl. H04Q 7/20; H04M 1/00

(52) U.S. Cl. 455/556.1; 455/466

(57) ABSTRACT

An electronic device that has a lower portion that unfolds to reveal an extendable keyboard. When the keyboard is folded closed, a number pad is visible and the device looks similar to a traditional portable or cellular telephone. The device can be used as a personal digital assistant, a cellular telephone, a cordless telephone or as the handset of a traditional wire line telephone. The fold-out keyboard of the electronic device can be used for easy entry of text data while a communication channel is active. The device includes two way messaging and Internet browsing capabilities.

### RELATED APPLICATION

This application claims priority to U.S. patent application Ser. No. 10/330,871 filed Dec. 24, 2002, and titled IMPROVED MOBILE ELECTRONIC DEVICE.

### BACKGROUND OF THE INVENTION

The present invention relates generally to the field of telephones and more specifically to a telephone with an extendable keyboard.

A cellular telephone is designed to give the user maximum freedom of movement while using a telephone. A cellular telephone uses radio signals to communicate between the “cell phone” and a base station, via an antenna. The served area is divided into cells something like a honeycomb, and an antenna is placed within each cell and connected by telephone lines to one exchange devoted to cellular-telephone calls. This exchange connects cellular telephones to one another and transfers the call to a regular exchange, public switched telephone network, if the call is between a cellular telephone and a non-cellular telephone. The special cellular exchange, through computer control, selects the antenna closest to the telephone when service is requested. As the telephone roams, the exchange automatically determines when to change the serving cell based on the power of the radio signal received simultaneously at adjacent sites. This change occurs without interrupting conversation. Practical power considerations limit the distance between the telephone and the nearest cellular antenna, and since cellular phones use radio signals, it is possible for unauthorized people to access communications carried out over cellular phones. One of the reasons why digital cell phones have gained in popularity, besides being able to access the Internet, is because their radio signals are harder to intercept and decode.

Analog transmission, in which speech or data is converted directly into a varying electrical current, is suitable for local calls. But once the call involves any significant distance, the necessary amplification of the analog signal can add so much noise that the received signal becomes unintelligible. For long-distance calls, the signal is digitized, or converted to a series of pulses that encodes the information. When an analog electrical signal is digitized, samples of the signal's strength are taken at regular intervals, usually about 8000 samples per second. Each sample is converted into a binary form, a number made up of a series of 1s and 0s. This number is easily and swiftly passed through the switching system. Digital transmission systems are much less subject to interfering noise than are analog systems. The digitized signal can then be passed through a digital-to-analog converter (DAC) at a point close to the receiving party, and converted to a form that the ear cannot distinguish from the original signal. There are several ways a digital or analog signal may be transmitted, including coaxial and fiber-optic cables and microwave and longwave radio signals sent along the ground or bounced off satellites in orbit around the earth. A coaxial wire, like the wire between a videocassette recorder (VCR) and a television set, is an efficient transmission system. A coaxial wire has a conducting tube surrounding another conductor. A coaxial cable contains several coaxial wires in a common outer covering. The important benefit of a coaxial cable over a cable composed of simple wires is that the coaxial cable is more efficient at carrying very high frequency currents. This is important because in providing transmission over long distances, many telephone conversations are combined using frequency-modulation (FM) techniques similar to the combining of many channels in the television system. The combined signal containing hundreds of individual telephone conversations is sent over one pair of wires in a coaxial cable, so the signal has to be very clear.

Fiber optic cable offer another telephone-transmission method that uses bundles of optical fibers, long strands of specially made glass encased in a protective coating. Optical fibers transmit energy in the form of light pulses. The technology is similar to that of the coaxial cable, except that the optical fibers can handle tens of thousands of conversations simultaneously. Another approach to long-distance transmission is the use of radio. Before coaxial cables were invented, very powerful longwave (low frequency) radio stations were used for intercontinental calls. Microwave radio uses very high frequency radio waves and has the ability to handle a large number of simultaneous conversations over the same microwave link. Because cable does not have to be installed between microwave towers, this system is usually cheaper than coaxial cable. On land, the coaxial-cable systems are often supplemented with microwave-radio systems. The technology of microwave radio is carried one step further by the use of communications satellites. Most communications satellites are in geosynchronous orbit—that is, they orbit the earth once a day over the equator, so the satellite is always above the same place on the earth's surface. That way, only a single satellite is needed for continuous service between two points on the surface, provided both points can be seen from the satellite. A combination of microwave, coaxial-cable, optical-fiber, and satellite paths now link the major cities of the world. The capacity of each type of system depends on its age and the territory covered, but capacities generally fall into the following ranges: Frequency modulation over a simple pair of wires like the earliest telephone lines yields tens of circuits (a circuit can transmit one telephone conversation) per pair; coaxial cable yields hundreds of circuits per pair of conductors, and thousands per cable; microwave and satellite transmissions yield thousands of circuits per link; and optical fiber has the potential for tens of thousands of circuits per fiber.

Computer-controlled exchange switches make it possible to offer a variety of extra services to both the residential and the business customer. Some services to which users may subscribe at extra cost are call waiting, in which a second incoming call, instead of receiving a busy signal, hears normal ringing while the subscriber hears a beep superimposed on the conversation in progress; and three-way calling, in which a second outgoing call may be placed while one is already in progress so that three subscribers can then talk to each other. Other services available to users are: caller ID, in which the calling party's number is displayed to the receiver on special equipment before the call is answered; and repeat dialing, in which a called number, if busy, will be automatically redialed for a certain amount of time. Of course users have the ability to block their name and phone from being displayed on a caller ID display. Another popular service is voice mail. While traditional answering machines cannot take a message if a caller is already on the line, voice mail creates a second virtual line. While a caller is talking to one party, a second incoming call is greeted with a message asking the second party to leave a message. The user will then be notified of the waiting message.

Unified messaging and the arrival of mobile Internet services means Short Message Service (SMS), a mobile messaging service, will soon become the primary alert mechanism for users to check and pick up their e-mail, fax or voice messages. Enhanced Message Service (EMS), Instant Messaging (ICQ), and Multimedia Message Service (MMS) message protocols can be expected to grow in popularity in the future. The rapidly growing availability of WAP (Wireless Application Protocol) has enabled handsets to enhance the customer experience of reading and sending more messages. The arrival of the GSM (Global System for Mobile communications) family's next phase of evolution in the form of GPRS (General Packet Radio Services) will ensure faster speeds and boost the variety of mobile services available significantly. Mobile banking, M-Commerce, and customer service applications are also bolstering SMS traffic. The arrival of more advanced data services will yet again increase demand. During the First (1 G) and Second (2 G) Generations of mobile communications different regions of the world pursued different mobile phone standards. Europe pursued NMT and TACS for analog and GSM for digital. North America pursued AMPS for analog and a mix of TDMA, CDMA and GSM for digital. The Third Generation (3 G), based on CDMA technology, will bring these incompatible standards together and allow convergence toward a common standard for mobile multimedia.

It is an object of the present invention to enrich the user's experience of the mobile Internet by facilitating efficient text entry while providing the capability to capture images with a camera and transmit the images. As mobile phones and computers converge towards unified handheld communication and computing devices, text messaging is becoming one of many ways in which text entry on handheld devices will be employed. Text entry is an integral part of the way users interact with computers in general and the Internet in particular. Simple text entry is required to query search engines, to find contacts in a phone list, to send email or instant messages and to enter commands. The inadequacy of currently used methods for entering text is the major obstacle inhibiting the growth of a wireless web and other applications, such as, Microsoft's Pocket Word and Pocket Excel. A numeric keypad such as that found in most cellular devices is poor device for entering strings of text data. For example, to enter certain letters a user must strike a key three times. A QWERTY-style keyboard on a mobile device is needed to provide an easy to use and familiar text entry solution. Such a device will help the mobile Internet achieve its full commercial potential for communication of all forms including voice, text and multi-media.

Currently researchers are studying keyboard design, and the following reference papers are examples. MacKenzie, S. I., Soukoreff, R. W., “Text entry for mobile computing: Models and Methods, Theory and Practice”, (in press) Human-Computer Interaction. Source: http://www.yorku.ca/mack/hci3.html. MacKenzie, S. I., Soukoreff, R. W., “A model of two-thumb text entry”, Proceedings of Graphics Interface 2002, pp 117-124. Toronto: Canadian Information Processing Society. Source http:H/www.yorku.ca/mack/gi2002.html.

Current devices for entering text on a mobile electronic device do not facilitate the use of the keys by the user. In many cases the keys are configured in less than optimum ways, with regard to position, location or key shape. It is an object of the present invention to overcome these problems.

An important feature of the present hand held electrical device is that data input through an extendable keyboard works in conjunction with launching and using wireless applications such as SMS, E-mail and web surfing, as well as an enter-then-act device user interaction paradigm. An enter-then-act device is disclosed in U.S. patent application titled “Enter-Then-Act Input Handling” Ser. No. 10/165,598, filed Jun. 7, 2002, which is incorporated herein by this reference.

Some mobile communication devices include a camera to provide a user with the ability to capture and transmit images. However, such devices have a number of shortcomings. For example, some mobile devices have an open and a closed position and include two displays, one to display data in each of the two positions. As another example, none of the present devices integrates the text entry advantages of a full QWERTY-style keyboard with a video camera.

It is another object of this invention to provide a relatively intuitive user interface both for text entry mode and for voice calling mode, and the interface is integrated with a camera.

Another object is to provide a mobile electronic device with camera in such a way that the device has a single display to display data entered into the device by typing and also images captured by the camera.

### SUMMARY OF THE INVENTION

An electronic device is provided for mobile communication of telephonic and image information as well as other data. In this case “telephonic” should be understood to mean voice communication and “data” should be understood to mean alphanumeric, such as text, and other information which can be entered by typing as well as digital and graphical information which can be drawings, pictures, etc. “Image” means visual information such as still and moving pictures. The present device is hand held and provides a user with text messaging and voice communications as well as the ability to capture, store, transmit and receive images. The device comprises: a display screen for displaying text and graphical information, such as icons, pictures and video, to the user. At least one speaker is provided for transmitting audio information, such as voice and music, to the user. Navigational buttons control basic functions of the device, such as on/off, initiation and termination of a telephone call, and selection and activation of icons or other data displayed on the display screen. A number pad allows the user to input numeric and text data wherein the number pad is a primary input device of telephone number data. At least one microphone is provided for receiving audio data, such as voice, from the user. Device software provides a graphical user interface for the device and controls operation of hardware provided in the device. A communication, control and memory system provides for transmission and reception of all data, voice, video, music and text from and to the device. A fold out section comprising approximately half of the portion of the device underneath the number pad unfolds in a direction perpendicular to a length of the device to reveal an extendable keyboard contained underneath the number pad. The extendable keyboard is usable with software applications on the device and provides the user with the ability to easily enter alphanumeric data and transmit the data over a wireless network.

The lens of a camera system is connected to the fold out section to capture visual images within the field of view of the lens. The lens is mounted on the face of the fold out section which is exposed when the fold out section is in the closed position. The camera system also includes a CCD or other means to capture the images received by the lens and convert the images to electrical signals which are transmitted to an image processing system. The image processing system allows the user to display the captured images on the display screen and to transmit the images to a remote location. With the camera system the user can carry out video conferencing by keeping the fold out section in the closed position so that the lens captures the user's face as he/she speaks into the microphone and views images of the other conferencing party on the display. The user also has the option of opening the fold out section which causes the lens to move relative to the body of the device and the field of view of the camera system to change depending on the orientation of the fold out section. This enables the user to capture images from practically any location relative to the body of the device while viewing the captured images on the display. The user can store the captured images or transmit them in real time as they are captured. The user can store and transmit the images along with his/her voice which is captured by the microphone.

The device can be used as a cellular telephone wherein the communication control unit includes an antenna that facilitates communication with a cellular base station. The device can also be used as a portable telephone in which case the communication control unit would include an antenna that facilitates communication with a portable telephone base that is connected, via a telephone line, to a public switched telephone network. The user can type on keys of the extendable keyboard to enter data and transmit the data from the device while a communication channel is open to a remote network. Capabilities of the device include the use of short messaging service (SMS) and similar services such as enhanced messaging service (EMS), multimedia messaging service (MMS), instant messaging (IM), picture messaging and text chat, as well as receiving and inputting data from and to the Internet via a mobile browser, and wireless data transmission applications that are compatible with SIM Application Toolkit and Wireless Application Protocol (WAP). Predictive text software is also provided and may be used when the device is in the open and closed positions.

### BRIEF DESCRIPTION OF THE DRAWINGS

The invention of the present application will now be described in more detail with reference to the accompanying drawings, given only by way of example, in which:

FIG. 1 is a front view of a preferred embodiment in the closed position;

FIG. 2 is a front view of a preferred embodiment in the open position;

FIG. 3 is an isometric view of the back of a preferred embodiment in the open position;

FIG. 4 is a block diagram of electronic components of a preferred embodiment of the present invention.

FIG. 5 is a schematic illustration showing how the present device functions as part of a wireless communication network.

### DETAILED DESCRIPTION OF THE INVENTION

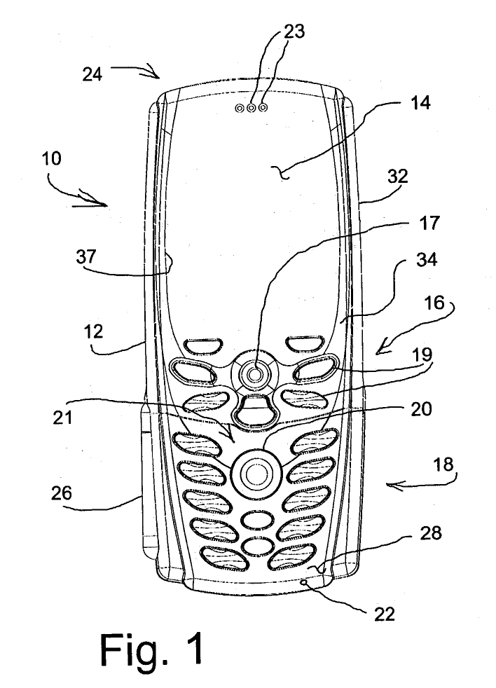

FIG. 1 shows a front view of a preferred embodiment wherein the extendable keyboard is folded closed and hidden underneath numeric keyboard 18. Electronic device 10 comprises housing 12, display 14, navigational pad 16, numeric keyboard 18, microphone 22, and speaker 23. The housing 12 is generally rectangular and has a left side 30, a right side 32, a front 34 and a back, which is not shown in this Figure. A hinge 26 is connected to the housing 12 and to a panel 28 comprising an extendable keyboard. The navigational pad 16 includes a joystick 17 and a plurality of navigation keys 19 which allow the user to perform certain functions on the display 14, including moving a cursor on the display. The joystick 17 and the navigation keys 19 can be considered to be pointing devices.

Display 14 provides visual output to the user. A display backlight 37 located around the periphery of the display 14 provides backlighting for use of the device at night. Display output can be text and graphics; icons, pictures, and videos. Navigational pad 16 allows the user to select options on a menu and activate various software programs, such as telephone and text communications enabling programs, which are loaded within device 10. The navigational pad 16 is configured similar to that of a conventional cellular telephone.

Numeric keyboard 18 functions in the same way as a traditional cellular or wire line telephone number pad to allow a user to place calls by dialing numbers, etc. On a traditional number pad the numbers 0-9 are typically represented on a 3×4 keypad matrix with the star symbol, zero and the # symbol residing on the bottom row of the matrix although the exact placement of these keys in this matrix fashion is not required. On numeric keyboard 18, the 12 keys are arranged in two columns of 5 keys each and one column of two keys.

On the numeric keyboard 18 a lens 20 of an image sensing system 21 is located between the two long rows of keys. The lens is of a conventional design of the type used in video cameras to capture still or moving images from its field of view in front of the device 10. Located behind the lens 20 are other components of the image sensing system 21, such as an image pickup element which can be a CCD or other similar device for converting the optical image into electrical signals and transmitting the signals to an image processing system 114 located in the device 10.

Microphone 22 is used to accept voice data from the user. Speaker 23 provides audio output to the user, and a speakerphone may also be supported. Antenna 24 is used for radio communication between device 10 and a remote location such as a cellular telephone base station. Of course, if device 10 is used as the handset of a traditional wire line phone, then no antenna is required.

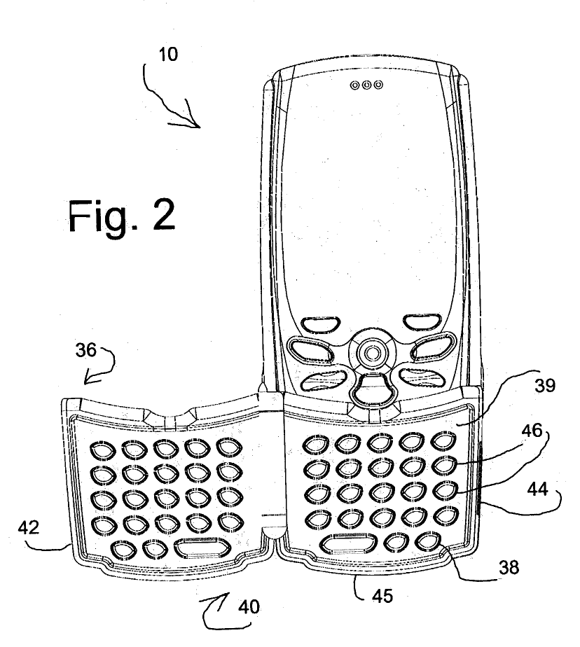

FIG. 2 shows electronic device 10 in the open position. The device 10 includes an extendable keyboard 40 which includes two sections, a left section 42 and a right section 44 which are coupled together by hinge 26. The left and right sections 42 and 44 have lower faces 43 and 45 which are in the same plane with each other when the device is in the open position. The keyboard includes a plurality of keys 46 which for the purpose of clarity are shown without their labels. The keys can be labeled and function as do the keys described in U.S. patent application Ser. No. 10/330,871 titled “Improved Mobile Electronic Device” filed Dec. 24, 2002, to which the present application claims priority. The keys 46 are translucent, and a keyboard backlight system 38 is provided to light the keys in certain circumstances.

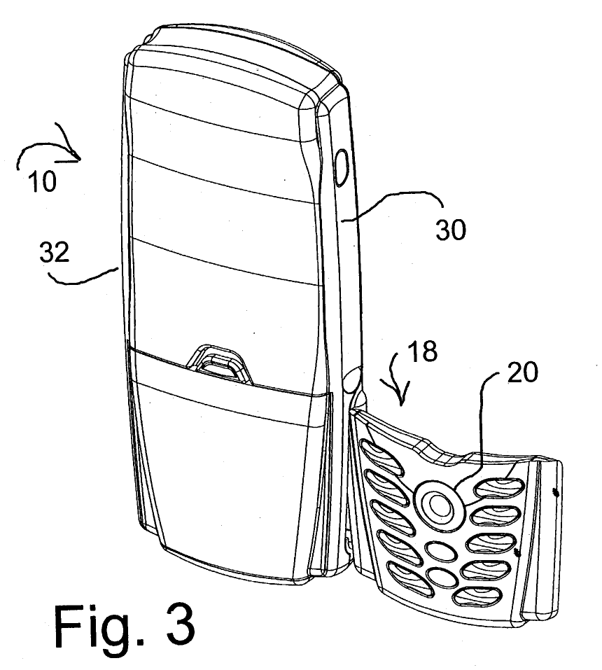

As shown in FIG. 2 the extendable keyboard 40 is in the open position and ready to receive keystrokes. In other words, the user has converted the device 10 from the configuration shown in FIG. 1 to the configuration shown in FIG. 2 by lifting the right side of the left section 42 so that it rotates about the hinge 26 and locks in the position shown in FIG. 2. A sensor 36 capable of sensing a magnetic field is located inside the left section 42 to sense whether the panel 28 is open or closed. A magnet 39 is located inside the right section 44 in a location which is adjacent the sensor 36 when the panel is closed. Still visible and ready for use while device 10 is in the open position are display 14, navigational pad 16, microphone 22, and speaker 23. The numeric keyboard 18 and lens 20 are not visible on the front of the device; they are on the opposite side of the folded out portion, i.e., behind the left section 42 of the keyboard 40, as shown in FIG. 3. In this case the numeric keyboard 18 is not easily accessible to the user, but it is not necessary for it to be easily accessible since in this configuration the user uses the extendable keyboard 40 for data entry.

The image sensing system 21 receives images according to the direction in which the user points the lens 20 and the field of view of the system 21. For example, the user can use the image sensing system much like a video camera and capture still or moving images by pointing the device 10. The images captured by the image sensing system 21 can be displayed on the display 14 to enable the user to assess what is being captured. Also, the user can transmit the images to a remote location in real-time, while the images are being captured, or he can store the images and later transmit them to a remote location. Transmission is accomplished via a wireless network, as described below. It should be noted that although in FIG. 3 the extendable keyboard 40 is shown in the fully open position, it can be oriented in a partly open position while images are captured by the image sensing system 21 so that the user can capture images at various locations relative to the device 10 while still viewing the images on the display 14. Although the hinge 26 shown in FIG. 3 allows the extendable keyboard 40 to rotate in only one plane relative to the display 14, alternative hinge systems could be used which allow for rotation in other planes as Well. In this way the user could point image sensing system in almost any direction while viewing the captured image on the display 14.

It should be understood that the hinge 26 could be located in other positions on the device to permit the keyboard to be folded in different ways. For example, the hinge 26 could be located on the right side of the device 10 so that the folded portion of the keyboard folds to the right side of the device rather than to the left side.

Turning now to FIG. 3, the back of the device is shown, with the fold out panel 28 in the open position. Thus it can be seen that the lens 20 points toward the rear of the device 10 to enable a user to capture images from behind the device.

The present device is intended to ease the typing burden on users that take advantage of cost efficient messaging services such as SMS. The Short Message Service (SMS) is the ability to send and receive text messages to and from mobile telephones. The text can comprise of words or numbers or an alphanumeric combination. SMS was created as part of the GSM Phase 1 standard. Each short message is up to 160 characters in length when Latin alphabets are used, and 70 characters in length when non-Latin alphabets such as Arabic and Chinese are used.

In operation, a network operator launches SMS Mobile Originate, software executed at base stations, to give customer true two-way SMS capability. Customers experiment with the service and work out new uses for it. Addition of a wireless Internet/mobile email service often follows, typically with the customer's mobile number becoming part of the email address they are allocated as part of the service. Emails sent to that address are forwarded as a short message to their wireless phone. Such a service tends to be popular with customers that don't already have an email address. Other information services are available. These services typically start with mainstream content such as news, travel, weather and sports.

The introduction of standardized protocols such as SIM Application Toolkit and the Wireless Application Protocol (WAP) have contributed to an increase in messaging usage by providing a standard service development and deployment environment for application developers and business partners. These protocols also make it easier for users to reply to and otherwise access messaging services through the provision of custom menus on the phone. The introduction of more friendly and easy to use terminals, such as device 10, will contribute to increases in messaging usage by providing simpler access to messaging services.

Mobile phone users sometimes prefer to communicate with each other using the Short Message Service. Typically, such person to person messaging is used to say hello or prompt someone for information or arrange a meeting or pass on some information. Such messages are usually originated from the mobile phone keypad. When the information to be communicated is short or it would take too long to have a full conversation or someone is traveling overseas or not available to take a voice call, SMS is an ideal messaging medium. For example, network operators typically charge the same to send a short message to someone in the same room as they do to someone traveling overseas with their mobile phone.

Because short messages are proactively delivered to mobile phones that are typically kept in the user's pocket and can be stored for later reference, SMS is often more convenient than email to communicate amongst distributed and mobile groups of people. Once users have familiarized themselves with reading and sending short messages, they often find that SMS is a useful way of exchanging information and keeping in touch with friends. This is particularly so when the recipient is also able to reply to messages for two-way communication. Simple person to person messaging generates a high volume of short messages. The most common use of SMS is for notifying mobile phone users that they have new voice or fax mail messages waiting. This is therefore the starting point for most mobile network operators and the first time that mobile phone users use SMS.

Whenever a new message is dispatched into the mailbox, an alert by SMS informs the user of this fact. Because SMS is already routinely used to alert users of new voice mail messages, this application may become one of the largest generators of short messages. Unified messaging is an emerging value-added network service that is particularly compelling because it elevates communication above the technology used to communicate; the message takes precedence over the media. The traditional message collection method is difficult to manage considering all of the different kinds of messages that people get; users have to log-on and pick up emails, pick up their faxes from the fax machine, call in and listen to voice mail and so on. Unified messaging involves providing a single interface for people to access the various different kinds of messaging they use such as fax, voice mail, short messages, and email. Now all of these types of messages can be conveniently accessed from a single point in the most actionable form. The user typically receives a short message notifying them that they have a new message in their unified messaging box. The short message often also includes an indication of the type of new message that has been deposited, such as fax, email or voice mail.

Unified messaging is a convenient application that is likely to become mainstream in the future. It should therefore be a significant generator of short messages as more services are launched. Upon receiving a new email in their mailbox, most Internet email users do not get notified of this fact. They have to dial in speculatively and periodically to check their mailbox contents. However, by linking Internet email with SMS, users can be notified whenever a new email is received. The Internet email alert is provided in the form of a short-message that typically details the sender of the email, the subject field and first few words of the email message. Most of the mobile Internet email solutions incorporate filtering, such that users are only notified of certain messages with user-defined keywords in the subject field or from certain senders. Users could find it expensive or inconvenient to be alerted about every email they receive (including unsolicited “spam” emails), which would reduce the value of the service. Because of the high and increasing usage of Internet email to communicate globally, and the benefit from using SMS to notify mobile users about important new email messages, this is likely to be a fast growing and popular application for SMS.

Another emerging SMS-based application is downloading ringtones. Ringtones are the tunes that the phone plays when someone calls it. With the same phone often sold with the same default tune, it is important for phone users to be able to change their ringtone to distinguish it from others. Phones often come with a range of different ringtones built into the phone's memory that the users can choose from. However, it has become popular to download new ringtones from an Internet site to the phone—these phones tend to be popular television or film theme tunes. Ringtone composers are also popular because they allow mobile phone users to compose their own unique ringtones and download them to their phones.

The Short Message Service can be used to deliver a wide range of information to mobile phone users from share prices, sports scores, weather, flight information, news headlines, lottery results, jokes to horoscopes. Essentially, any information that fits into a short message can be delivered by SMS. Information services can therefore be configured as push-based and from a public or private source or pull-based and from a public or private source. An information service for an affinity program may combine public information such as share prices with private information from bank databases. Successful information services should be simple to use, timely, personalized and localized.

Electronic commerce applications involve using an electrical device such as a mobile phone for financial transaction purposes. This usually means making a payment for goods or transferring funds electronically. Transferring money between accounts and paying for purchases are extremely popular electronic commerce applications. The convenience of paying for purchases using SMS must be weighed against the related issues of security, integration with the retail and banking hardware and systems, and money transfer issues. However, this area of electronic commerce applications is expected to contribute significantly to the growing amount of SMS traffic. The cellular telephone embodiment of the present device is tailored toward taking advantage of all of the above features of SMS by providing an extendable keyboard for text entry.

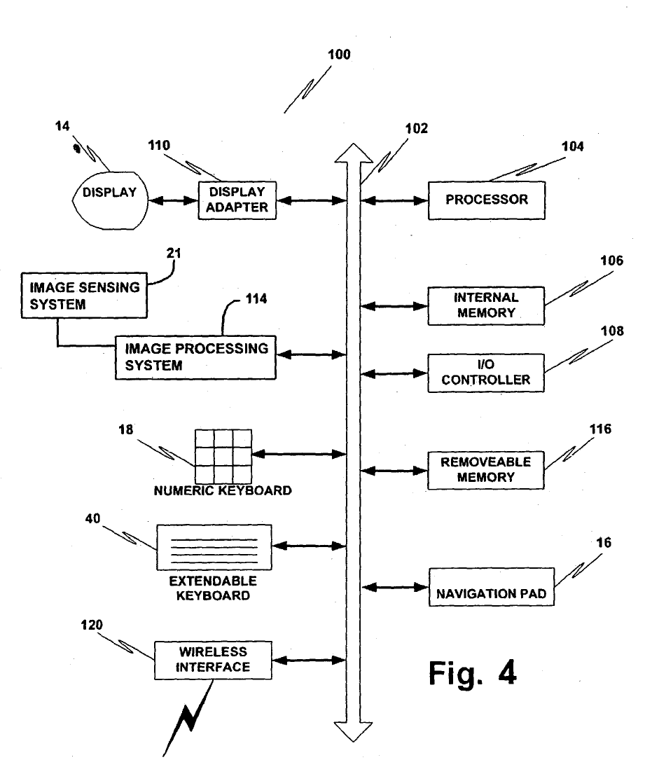

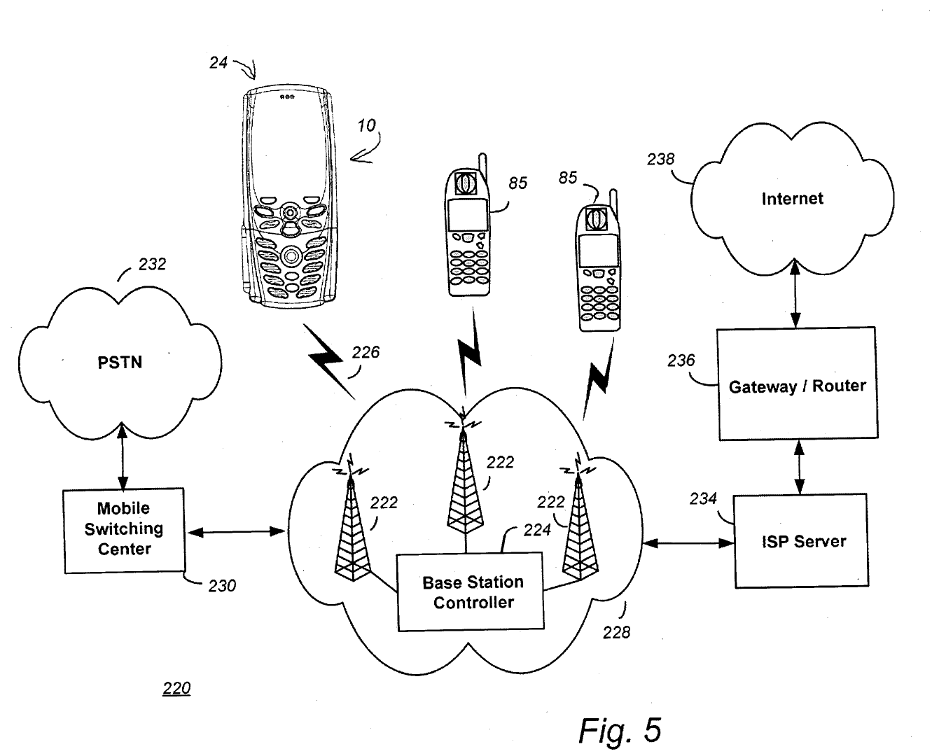

FIG. 4 depicts a block diagram of a control, communication and memory system 100 suitable for implementing aspects of the present invention. As shown in FIG. 4, system 100 includes a bus 102 which interconnects major subsystems comprising a processor 104, an internal memory 106 (such as a RAM), an input/output (I/O) controller 108, a removable memory (such as a memory card),not shown, the display 14 via display adapter 110, the navigational pad 16, the numeric keyboard 18, the extendable keyboard 40, a wireless interface 1320, and image processing system 114. The image processing system 114 is connected to the image sensing system 21 to process data received therefrom. Together, the image processing system 114 and the image sensing system 21 can be considered to be a camera system. Wireless interface 112 may be used to interface to a local or wide area network (such as the Internet) as discussed in connection with FIG. 5. Code to implement the present invention may be operably disposed in internal memory 115 or stored on storage media such as removable memory 116.

FIG. 5 illustrates how device 10 may be configured in a wireless communications system 220 to communicate voice, images and data to and from a remote electronic device. According to embodiments of the present invention, a user may utilize the extendable keyboard 40 of device 10 and the image sensing system 21 and image processing system 114 to send data and images over the Internet to a remote device or directly to a hand-held electronic device over a network 228. Antenna 24 of device 10 transmits and receives RF signals modulated by data and voice information to and from one of base stations 222 over a wireless link 226 to wireless network 228. Base station controller 81 transmits and receives voice modulated signals to and from a mobile switching center 224, which communicates with a remote device (e.g. a telephone) over the PSTN (Public Switched Telephone Network) 232. Base station controller 224 also transmits and receives data modulated signals to and from an ISP (Internet Service Provider) Server 234. ISP server 234 transmits and receives data to and from a gateway/router 236, which sends and receives the data to and from a remote device over the Internet 238 using, for example, Session Initiated Protocol (SIP). Data entered from keyboard 40 and the image sensing system 21 of device 10 may also be transmitted by antenna 24, over wireless network 228, to a remote hand-held electronic device 85 using the SMS, SIM, WAP protocols, or the like. Wireless network 228 may comprise any circuit-switched network, any connectionless packet-switched signaling network, any two-way paging network, and may support cellular technologies such as, for example, PCS, GSM (global System for Global Communication), GPRS (General Packet Radio Service), CDMA (Code Division Multiple Access), TDMA (Time Division Multiple Access), or W-CDMA (Wideband Code Division Multiple Access). The communication, control and memory means 100 of the present device can establish a connection through a communication channel using circuit switched or packet switched means or other, similar means. It should be understood that the wireless network 228 can include short range wireless technologies such as Bluetooth or others which include wireless Ian 802.11b, 802.11a, 802.11g, infrared, and ultrawideband.

The foregoing description of the specific embodiments will so fully reveal the general nature of the invention that others can, by applying current knowledge, readily modify and/or adapt for various applications such specific embodiments without departing from the generic concept. For instance, the display screen could be made larger to dominate the front of the device and/or a pointing device could be incorporated to aid data input. Also, it would be possible to incorporate alternative or additional hinge systems so that e.g. the display screen could fold over or under the keyboard. Therefore, such adaptations and modifications should and are intended to be comprehended within the meaning and range of equivalents of the disclosed embodiments. It is to be understood that the phraseology of terminology employed herein is for the purpose of description and not of limitation. Also, it should be understood that although SMS has been discussed extensively, capabilities of the device also include similar services such as enhanced messaging service (EMS), multimedia messaging service (MMS), instant messaging (IM), picture messaging and text chat, as well as receiving and inputting data from and to the Internet.

We claim:

1. A mobile electronic communication device, comprising:
a) a housing;
b) a display connected to said housing;
c) an extendable keyboard connected to said housing, and,
d) a camera system including an image sensing system connected to said extendable keyboard.

2. The device of claim 1 further including control, communication and memory means connected to said housing and coupled in electronic communication with said camera system to permit a user to transmit data captured by said camera system.

3. The device of claim 1 further including control, communication and memory means connected to said housing and coupled in electronic communication with said extendable keyboard to permit a user to enter data and transmit the data using said extendable keyboard.

4. The device of claim 1 wherein said extendable keyboard is connected to said housing by a hinge.

5. The device of claim 1 further including an auxiliary pointing device.

6. The device of claim 1 further including at least one antenna.

7. The device of claim 1 further including a power supply.

8. An electronic device for telephonic, data and video communication, comprising:
a) a housing;
b) a display connected to said housing;
c) a speaker connected to said housing;
d) a numeric keyboard connected to said housing;
e) a microphone connected to said housing;
f) an extendable keyboard connected to said housing, said extendable keyboard comprising a first section and a second section, said first section being coupled to said second section by a hinge so that said keyboard has an open position and a closed position;
g) an image processing system connected to the housing;
h) an image sensing system connected to the extendable keyboard and coupled in electronic communication with said image processing system and said display;
i) a plurality of keys connected to said extendable keyboard; and,
j) control, communication and memory means connected to said housing and coupled in electrical communication with said extendable keyboard to permit a user to enter data and transmit the data using said extendable keyboard and coupled in electrical communication with said image processing system to permit a user to transmit data captured by said image processing system.

9. A device according to claim 8 wherein when said keyboard is in the open position said second section is adjacent to the housing, and said plurality of keys are exposed to permit a user to type using said keys.

10. A device according to claim 8 wherein when said keyboard is in the open position said second section of the keyboard forms a panel located adjacent said housing.

11. An electronic device for telephonic, video and data communication, comprising:
a) a housing having an lower face and an axis which is substantially perpendicular to said lower face;
b) a display connected to said housing;
c) a speaker connected to said housing;
d) a numeric keyboard connected to said housing;
e) a microphone connected to said housing;
f) an extendable keyboard connected to said housing, said extendable keyboard comprising a plurality of keys, said extendable keyboard having a first segment to one side of the axis and a second segment to the other side of the axis;
g) an image sensing system coupled to said extendable keyboard; and,
h) control, communication and memory means connected to said housing and coupled in electronic communication with said extendable keyboard to permit a user to enter data and transmit the data using said extendable keyboard.

12. A device according to claim 11 wherein said extendable keyboard has a first position and a second position, wherein in the first position the keyboard is closed and in the second position the keyboard is open.

13. A device according to claim 11 wherein said hinge is constructed so that said keyboard can be rotated about said hinge to enable said image sensing system to sense images in a variety of directions relative to said housing.

14. A device according to claim 11 wherein said control, communication and memory means are constructed so that the image captured by said image sensing system can be displayed on said display.

15. A device according to claim 11 wherein said numeric keypad is located on one face of said extendable keyboard and said image sensing system is coupled to the same face of said extendable keyboard.

16. A process for using a mobile electronic communication device which can be held by a user, the device having a display, an extendable keyboard and an image sensing system connected to the extendable keyboard, the process comprising:
a) positioning the extendable keyboard relative to the mobile electronic communication device so that the image sensing system captures an image of the user of the device; and,
b) displaying on the display the image of the user.

17. The process according to claim 16 further including the step of transmitting the image of the user to a remote location.

18. The process according to claim 12 wherein the user types on keys comprising the extendable keyboard and transmits the typed data to a remote location.

19. A process for using a mobile electronic communication device which can be held by a user, the device having a display, an extendable keyboard and an image sensing system connected to the extendable keyboard, the process comprising:
a) positioning the extendable keyboard relative to the mobile electronic communication device so that the image sensing system captures an image of an object which is spaced apart from the user of the device;
b) displaying on the display the image of the object.

20. A process according to claim 15 further including the step of transmitting the image of the object to a remote location.
